(19) United States
(12) Patent Application Publication
(10) Pub. No.: US 2008/0221264 A1
(43) Pub. Date: Sep. 11, 2008

(54) Self-Adhesive Silicone Compositions For Unpressurized Vulcanization

(75) Inventor: Juergen Weidinger, Polling-Ehring (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/037,255

(22) Filed: Feb. 26, 2008

(30) Foreign Application Priority Data
Mar. 7, 2007 (DE) 10 2007 011 159.4

(51) Int. Cl. C08L 83/04; C08K 3/36

(52) U.S. Cl. 524/588

(57) ABSTRACT

Self-adhesive silicone elastomer compositions contain as ingredients:
(A) at least one siloxane-containing polymer having organic radicals capable of crosslinking,
(B) at least one treated or untreated, fumed or precipitated silica,
(C) at least one silicate having thermally or hydrolytically cleavable leaving groups O—R², which are silicate salts or low molecular weight silicate compounds, where R² is H, an organic radical, or, instead of O—R², a halogen,
(D) at least one resin forming monomer or oligomer with a linear structure, with the proviso that silicates are not included,
(E) at least one suitable crosslinking system selected from the group containing peroxide-induced crosslinking or noble metal catalyzed addition crosslinking.

### BACKGROUND OF THE INVENTION

1. Field of the Invention

The invention relates to self-adhesive silicone compositions and also to silicone elastomers and composite materials produced from these compositions.

2. Background Art

The adhesion of silicone elastomers to numerous substrates such as plastics, metals, and glasses, is known to be poor, owing to the inert character of the silicone (siloxane) polymers. Thus, when a silicone elastomer material is applied to a substrate and subsequently crosslinked, the resulting silicone elastomer can generally be easily peeled from the substrate surface, in other words through application of low tensile forces. Frequently, indeed, spontaneous detachment of the silicone elastomer from the substrate is observed. The adhesion is reduced still further in the case of addition crosslinking silicone elastomers. However, since numerous applications place critical importance on strong and sustained adhesion of the silicone elastomer to the substrate, a multiplicity of specific measures have been proposed for achieving a strong bond between substrate and silicone elastomer.

In principle, the strength of adhesion of the silicone elastomer/substrate assembly can be increased by appropriately altering the chemical and/or physical characteristics of the substrate or the substrate surface before the addition crosslinking silicone elastomer composition is applied. This can be done, for example, by pretreatment of the substrate surface with adhesion promoter additives (known as primers), by plasma treatment of the substrate surface, etc. One of the disadvantages of these measures is that additional process steps are required or specific requirements must be imposed on the characteristics of the substrate.

The strength of adhesion of the silicone elastomer/substrate assembly can be increased, furthermore, by selective alteration of the chemical and/or physical characteristics of the silicone elastomer material. There are numerous known adhesion promoter additives which, when admixed with the uncrosslinked silicone material, induce self-adhesion of the resulting silicone elastomer to diverse substrates. They include compounds containing highly reactive functional groups, such as alkoxy, epoxy, carboxyl, amino, etc, these groups usually being selected such that the adhesion promoter is able to react both with the substrate and with a silicone elastomer constituent. Although such adhesion promoters may possibly make it unnecessary to pretreat the substrate, the strength of adhesion achieved nevertheless frequently fails to meet the requirements imposed. In addition, the possibilities for increasing the strength of adhesion by means of higher levels of these adhesion promoters are limited, since in that case the highly reactive groups they contain have increasingly adverse consequences for service properties such as storage stability, crosslinking characteristics (inhibition), toxicological safety, etc. For these reasons, the focal point of interest is instead directed to minimizing adhesion promoter content.

EP 0 686 671 A2 describes a self-adhesive addition crosslinking material which manages without specific adhesion promoters because the adhesion promoting constituent either is an organohydropolysiloxane which on average possesses per molecule at least two SiH groups and whose monovalent Si-bonded radicals are composed to an extent of at least 12 mol % of hydrocarbon radicals featuring an aromatic ring, or is a compound of this kind which possesses on average per molecule at least one SiH group and contains a group consisting of two aromatic rings, the two aromatic rings being separated from one another by —R¹³R¹⁴Si—, R¹³R¹⁴SiO—, —OR¹³R¹⁴SiO— or —R¹³R¹⁴SiOR¹³R¹⁴Si—, where the radicals R¹³ and R¹⁴ represent monovalent hydrocarbon radicals. The adhesion promoting constituent, accordingly, can also be the crosslinker of the silicone elastomer material. This composition achieves effective adhesion to organic plastics (especially ABS), while at the same time there is a reference to ease of demolding from the metal vulcanizing mold (chromium coated or nickel coated steel molds or molds made from aluminum alloy). The high level of >12 mol % of radicals containing aromatic rings in the SiH-containing, adhesion promoting constituent, however, results in considerable incompatibility with the remaining constituents of the addition crosslinking silicone elastomer material. This leads on the one hand to partial separation (exudation) during storage, which necessitates repeated homogenizing of the component comprising this constituent prior to use. This incompatibility, which is apparent as a milky haze even in the uncrosslinked material, is also manifested in significantly reduced transparency of the silicone elastomer parts produced from it. If the adhesion promoting constituent also acts as the crosslinker of the silicone elastomer composition, the incompatibility also leads to vulcanization defects, which result in nonhomogeneous network formation and in deficient mechanical properties of the vulcanizate. In order to avoid these vulcanization defects, it is necessary to use not only the adhesion promoting SiH-containing constituent but also an SiH-containing crosslinker which is completely compatible with the silicone elastomer material, but doing so results in other disadvantages, for example, increased compression set, and increased exudation tendency on the part of the adhesion promoting constituent. The high level of radicals containing aromatic rings in the SiH-containing, adhesion promoting constituent, of >12 mol %, also causes the silicone elastomer material to have a considerable structural viscosity and thixotropy, which in numerous applications, for example injection molding of liquid silicone rubber, are undesirable. Finally, the adhesion of this composition to metals is inadequate as well.

EP 0 875 536 A2 describes a self-adhesive addition crosslinking silicone rubber mixture with the following features:

a) the SiH crosslinker contains at least 20 SiH groups, other radicals being aliphatically saturated;

b) an epoxy-functional alkoxysilane and/or alkoxysiloxane is included; and

c) optionally, a peroxide is also included.

Particular preference is given in this context to the use of glycidyloxypropyltrimethoxysilane (Glymo). The silicone rubber mixture EP 0 875 536 A2 describes is particularly suitable for the production of composite moldings composed of the silicone elastomer and an organic plastic. The composition however, has the disadvantage that sufficient adhesive strength can be only obtained when using the very SiH-rich crosslinkers, having on average at least 20 SiH groups per molecule. The examples actually employ crosslinkers having 30 SiH groups per molecule. The use of such highly functional crosslinkers considerably reduces the storage stability of addition crosslinking silicone rubber mixtures: that is, the fluidity is massively impaired, possibly going as far as the stiffening of the material, as a result of which the proper processing of the material, for example by injection molding, is no longer possible. Furthermore, in order to obtain a high strength of adhesion, it is necessary to use relatively large amounts of epoxy-functional alkoxysilane/-siloxane, thereby considerably reducing the crosslinking rate. Although this can be partly compensated through the use of a peroxide, as described in EP 0 875 536 A2, it is nevertheless the case that the only peroxides suitable for this purpose, on account of the low crosslinking temperature required (softening of the organic plastic), are peroxides having a low initiation temperature, such as the 2,4-dichlorobenzoyl peroxide described therein, and peroxides of this kind on the one hand are very objectionable toxicologically owing to the cleavage products and secondary products that are liberated (PCB problem), and, on the other hand, further impair the storage stability of the material.

None of the conventional peroxidically crosslinking or addition crosslinking silicone elastomer compositions, then, satisfactorily do justice to the requirements that are imposed on a self-adhesive silicone elastomer material that is to be used, for example, for producing composite moldings or for encapsulating electrical/electronic parts, including:
a) high fluidity and storage stability
b) high crosslinking rate at relatively low temperatures
c) high strength of adhesion to organic plastics, metals, and glasses
d) ease of demolding from vulcanizing molds
e) toxicological safety
f) high level of service properties, e.g. transparency, noncorrosiveness, and mechanical property profiles.

EP 1 106 662 B1 describes addition crosslinking silicone elastomers which, to a large extent, no longer have the abovementioned disadvantages, as a result of the use of suitable crosslinker molecules. However, all of the silicone compositions set out in EP 1 106 662 B1 and in the prior art cited earlier on above require the presence of pressure, e.g. internal mold pressure or applied compression pressure, for developing adhesion to the substrate, and at the same time, for defect-free vulcanization. This means that they are pure molding compounds, injection molding compounds or, to put it more generally, shaped article compounds.

Major applications in the composite article sector, however, entail not just the discontinuous operation of molding processes but instead involve continuous manufacturing operations, such as extrusion and the related calendering and coating. Common to these operations is the fact that vulcanization must take place without pressurization, and in a very short time. Heightened requirements are therefore imposed on silicone compositions which are used for the continuous operations, such as
a) increased consistency (viscosity) in order to maintain geometry in the unvulcanized state
b) rapid vulcanization
c) maximally reduced bubble formation tendency
d) low extrusion swelling.

With the exception of requirement b), the additives of the prior art negatively impact all of these properties, and hence would render the continuous, defect-free production of parts impossible from the outset. Furthermore, it has been found that even when bubble formation, rough surfaces, and deformations in the extruded part are tolerated, the development of adhesion under the conditions of unpressurized continuous manufacture is too slow, and hence the adhesive bonding is unsatisfactory. Furthermore, bubbles at the interface massively weaken the adhesion. The following additional requirements of a self-adhesive extrudable or calenderable material are therefore met inadequately, or not at all, by the materials described in the prior art:
e) very rapid development of initial adhesion
f) rapid development of high quality transport adhesion or, preferably, immediate development of an adhesive force near or equal to the final adhesion
g) high absolute final adhesion value without aftertreatment
h) no influence on mechanical and chemophysical properties with the material as a result of modified adhesion
i) no influence on properties relevant to processing, e.g. consistency, extrusion swelling, and tendency toward bubble formation, as a result of modified adhesion.

### SUMMARY OF THE INVENTION

An object of the invention, therefore, was to provide a peroxidically or addition crosslinking silicone elastomer composition which self-adheres well to a wide variety of substrates, such as organic plastics, fibers/fabrics, metals, glass, and ceramics, for example, which does not have the disadvantages of the compositions described in the prior art, and which meets the requirement profiles set forth above. These and other objects are surprisingly achieved be a composition containing:

(A) at least one siloxane containing a polymer having organic radicals capable of crosslinking,

(B) at least one treated or untreated, fumed or precipitated silica,

(C) at least one silicate having thermally or hydrolytically cleavable leaving groups O—R², selected from among silicate salts or low molecular weight silicate compounds, where R² is H, an organic radical or, instead of O—R², a halogen as a leaving group,

(D) at least one resin forming monomer or oligomer with a linear structure, with the proviso that silicates are not included, and

(E) at least one suitable crosslinking system comprising peroxide-induced crosslinking or noble metal catalyzed addition crosslinking.

### DETAILED DESCRIPTION OF THE PREFERRED EMBODIMENT(S)

The invention thus provides silicone elastomer compositions comprising

(A) at least one siloxane containing a polymer having organic radicals capable of crosslinking,

(B) at least one treated or untreated, fumed or precipitated silica,

(C) at least one silicate having thermally or hydrolytically cleavable leaving groups O—R², selected from among silicate salts or low molecular weight silicate compounds, where R² is H, an organic radical or, instead of O—R², a halogen as a leaving group,

(D) at least one resin forming monomer or oligomer with a linear structure, with the proviso that silicates are not included, and

(E) at least one suitable crosslinking system comprising peroxide-induced crosslinking or noble metal catalyzed addition crosslinking.

The compositions of the invention can be one component or multicomponent materials. In the latter case the components of the compositions of the invention may comprise all constituents in any desired combination. Surprisingly it has been found that the requirements of all of items a) to i) set out above are met by the compositions of the invention, which bind to the substrate not, as hitherto, via a combination of polymers/oligomers and additives and/or crosslinkers, but instead via the filler (B).

Preferably the crosslinking capable organic radicals of compound (A) are aliphatic carbon-carbon multiple bonds. The constituent (A) is preferably an aliphatically unsaturated organosilicon compound, in which context it is possible to employ all aliphatically unsaturated organosilicon compounds that are useful in crosslinking materials, without limitation including those, for example, such as silicone block copolymers with urea segments, silicone block copolymers with amide segments and/or imide segments and/or ester-amide segments and/or polystyrene segments and/or silarylene segments and/or carborane segments, and silicone graft copolymers with ether groups.

The molecular weight of constituent (A) can vary within wide limits, for instance between 10² and 10⁶ g/mol. Thus, for example, constituent (A) may be an alkenyl-functional oligosiloxane of relatively low molecular weight, such as 1,2-divinyltetramethyldisiloxane, or alternatively can be a high-polymer polydimethylsiloxane which possesses pendant or terminal Si-bonded vinyl groups and has, for example, a molecular weight of 10⁵ g/mol (number average determined by means of NMR). The structure of the molecules forming constituent (A) is not fixed either; the structure of a siloxane of relatively high molecular weight, in other words oligomeric or polymeric, may more particularly be linear, cyclic, branched or else resinlike, networklike. Linear and cyclic polysiloxanes are preferably composed of units of the formula R₃SiO_{1/2}, R¹R₂SiO_{1/2}, R¹RSiO_{2/2}, and R₂SiO_{2/2}, it being possible for R and R¹ to be any desired organic or inorganic substituents, and are preferably halogen-substituted and/or organo-substituted linear and branched siloxanes having 1 to 10 Si—O units, more preferably organo-substituted siloxanes having terminal and pendant OH functions produced by leaving groups. Branched and networklike polysiloxanes additionally contain trifunctional and/or tetrafunctional units, preference being given to those of the formulae RSiO_{3/2}, R¹SiO_{3/2}, and SiO_{4/2}. It will be appreciated that mixtures of different siloxanes meeting the criteria of constituent (A) can also be used.

Particular preference as component (A) is given to the use of vinyl-functional, substantially linear polydiorganosiloxanes having a viscosity of 0.01 to 500,000 Pa·s, most preferably from 0.1 to 100,000 Pa·s, at 25° C. The component (A) content of the crosslinkable material of the invention is situated in the range from about 40% to 90% by weight, preferably about 55% to 85% by weight. The term “about” as used herein also is inclusive of the literal ranges disclosed.

As fillers (B) it is possible to use all fillers from the group of the silicas which are useful in silicone materials. Examples are fumed or precipitated silicas having BET surface areas of at least 50 m²/g, preference being given to fumed and precipitated silicas having BET surface areas of at least 50 m²/g.

The silica fillers (B) may have a hydrophilic character or may have been hydrophobized by known methods. If hydrophilic fillers are incorporated it is necessary to add a hydrophobizing agent. Particularly preferred as component (B) are silicas which still contain some hydrophilic groups, in the form of unmodified OH groups or OH groups substituted by organosilyl resins, and therefore still have partly hydrophilic character and/or can form hydrophilic groups in situ by elimination of organic leaving groups such as —OMe, —OEt, or —OAc.

The content of the actively reinforcing filler (B) in the crosslinkable material of the invention is situated in the range from about 0.5% to 70% by weight, preferably about 5% to 50% by weight. The components (A) and (B) used in accordance with the invention are commercially customary products and/or can be prepared by processes which are common in chemistry.

Silicates (C) may be silicate salts or linear or branched silicate compounds of low molecular weight which have thermally or hydrolytically cleavable O—R² bonds, where R² has the definition recited above. Preference is given to silicates (C) of the general formula (1),

R³R⁴SiR⁵R⁶, (1)

where R³, R⁴, R⁵, and R⁶ can be an organic or inorganic radical, a substituent of the structure —O—R⁷, or a halogen radical, where R⁷ is H or any desired organic radical. With particular preference the radicals R³, R⁴, R⁵ and R⁶ are a preformed small and easily eliminatable leaving group, such as, for example, —OMe, —OEt, —OAc, or a reactive halogen such as —Cl, or —Br.

In a further embodiment, it is possible for at least one of the radicals, R³, R⁴, R⁵ or R⁶, to have been replaced by an —O— and so to lead to a low molecular weight, three dimensional continuation of the silicate tetrahedron structure. The low molecular weight silicate compounds are preferably composed of up to 100 Si—O units.

The component (C) content of the crosslinkable material of the invention is situated in the range from about 0.3% to 30% by weight, preferably about 1% to 10% by weight. The starting materials (C) used in accordance with the invention are known to the skilled worker, in some cases may be acquired commercially, and may be prepared by processes common in chemistry.

The resin formers (D) are monomers or oligomers with a linear structure, with the proviso that silicates are not included. Preference for (D) is given to compounds of the general formula (2)

R⁸R⁹(R¹⁰O)Si—OR¹¹ (2)

where R⁸ and R⁹ can be any desired organic or inorganic substituents, preferably halogen-substituted and/or organo-substituted linear and branched siloxanes having 1 to 10 Si—O units, and with particular preference, organo-substituted siloxanes having terminal and/or pendant OH functions produced by leaving groups. R¹⁰ and R¹¹ may likewise be any desired organic or inorganic compounds, but with the proviso that at least one of the two has a preformed leaving group, an example being a substituent —CH₃, —CH₂CH₃, —C(O)CH₃, etc. Preference as radical R¹⁰, R¹¹ is therefore given to short-chain organic compounds, with particular preference to methyl, ethyl or acetyl groups.

The starting materials (D) used in accordance with the invention are known to the skilled worker, in some cases may be acquired commercially, and may be prepared by processes common in chemistry. The content of component in the crosslinkable material of the invention is situated in the range from about 0.1% to 20% by weight, preferably about 0.5% to 5% by weight.

As a crosslinker system (E) it is possible to use all peroxide induced or noble metal complex catalyzed addition crosslinking systems which are useful in the art. Where the crosslinking of the compositions of the invention takes place by means of free radicals, the crosslinking agents used are organic peroxides which serve as a source of free radicals. Examples of organic peroxides are acyl peroxides such as dibenzoyl peroxide, bis(4-chlorobenzoyl)peroxide, bis(2,4-dichlorobenzoyl)peroxide, and bis(4-methylbenzoyl)peroxide; alkyl peroxides and aryl peroxides such as di-tert-butyl peroxide, 2,5-bis(tert-butylperoxy)-2,5-dimethylhexane, dicumyl peroxide, and 1,3-bis(tert-butylperoxyisopropyl)benzene; perketals such as 1,1-bis(tert-butylperoxy)-3,3,5-trimethylcyclohexane; peresters such as diacetyl peroxydicarbonate, tert-butyl perbenzoate, tert-butyl peroxyisopropyl carbonate, tert-butyl peroxyisononanoate, dicyclohexyl peroxydicarbonate, and 2,5-dimethylhexane-2,5-diperbenzoate. It is possible to use one kind of organic peroxide; it is also possible to use a mixture of at least two different kinds of organic peroxides.

As catalysts which promote the addition of Si-bonded hydrogen to aliphatic multiple bonds it is also possible in the case of the process of the invention to use any catalysts which are useful to promote the addition of Si-bonded hydrogen to aliphatic multiple bonds. The catalysts are preferably a metal from the group of the platinum metals, or a compound or a complex of a metal from the group of the platinum metals. Examples of such catalysts are metallic and finely divided platinum, which can be located on supports such as silicon dioxide, aluminum oxide or activated carbon, or compounds or complexes of platinum, such as platinum halides, examples being PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without the presence of detectable inorganically bonded halogen, bis(gamma-picoline)platinum dichloride, trimethylenedipyridineplatinum dichloride, dicyclopentadieneplatinum dichloride, dimethyl sulfoxide-ethyleneplatinum(II) dichloride, cyclooctadieneplatinum dichloride, norbomadieneplatinum dichloride, gamma-picolineplatinum dichloride, cyclopentadieneplatinum dichloride and also reaction products of platinum tetrachloride with olefin and primary amine or secondary amine or both primary and secondary amine, such as the reaction product of a 1-octene solution of platinum tetrachloride with sec-butylamine, or ammonium-platinum complexes.

Besides components (A) to (E) the compositions of the invention may further comprise additional substances which are useful for preparing silicone materials, including those substances which have been used to date to improve the adhesion, i.e. adhesion promoters.

The silicone compositions of the invention may optionally comprise, as constituent(s) (F), further adjuvants, in a fraction of up to 10% by weight, preferably 0.0001% to 4% by weight, which may act as a catalyst, cocatalyst or initiator for cleavage reactions and condensation reactions of O—R bonds, such as:

metal complexes or noble metal complexes, preferably tetra-organo-substituted complexes, with particular preference tetra-organo-substituted tin, titanium, and zirconium complexes;

acidic or basic ionic and nonionic compounds, such as alkali metal salts and alkaline earth metal salts of organic and inorganic acids and bases, preferably acetates, sulfonates, sulfates, and phosphates, and ammonium salts; and

all further organic and inorganic compounds capable of destabilizing or cleaving O—R bonds or of catalyzing their cleavage or destabilization.

The silicone compositions of the invention may optionally comprise, as constituent(s) (G), further adjuvants, in a fraction of up to 70% by weight, preferably 0.0001% to 40% by weight. These additives may be, for example, inert fillers, resinous polyorganosiloxanes different than the siloxanes (A), (C), and (D), dispersing assistants, solvents, adhesion promoters, pigments, dyes, plasticizers, organic polymers, heat stabilizers, etc. These include adjuvants such as finely ground quartz, diatomaceous earth, clays, chalk, lithopones, carbon blacks, graphite, metal oxides, metal carbonates, metal sulfates, metal salts of carboxylic acids, metal dusts, fibers, such as glass fibers and polymeric fibers, polymeric powders, metal dusts, dyes, and pigments, etc.

Also present may be adjuvants (H) which serve for selective adjustment of the processing time, initiation temperature, and crosslinking rate of the compositions of the invention.

The organopolysiloxane materials of the invention may where necessary be dissolved, dispersed, suspended or emulsified in liquids. Depending more particularly on the viscosity of the constituents and on the filler content, the compositions of the invention may be of low viscosity and may be pourable, may have a pastelike consistency, may be in powder form, or else may constitute smooth materials of high viscosity, such as may be the case, as is known, for the materials frequently referred to by those in the art as RTV-1, RTV-2, LSR, and HTV materials. In terms of the elastomeric properties of the crosslinked silicone materials of the invention, again, the entire spectrum is covered, beginning with extremely soft silicone gels and ranging via rubberlike materials through to highly crosslinked silicones with glasslike properties.

The process for producing composite moldings from the silicone elastomer composition of the invention may take place, for example, by coextrusion, calendering, and overmolding, with and without exposure to pressure. Particularly preferred materials are those which allow processing by the methods of extrusion, calendering, and coating—that is, materials which are commonly known as solid silicone, HTV or HCR, or else, for coating, materials known as RTV or LSR.

The silicone compositions of the invention can be produced by known processes, such as, for example, by uniform mixing of the individual components (A) to (E) and, optionally, the further components (F) to (H). The order of mixing is arbitrary. This mixing takes place as a function of the viscosity of (A), for example, with a stirrer, in a dissolver, on a roll, or in a compounder. The filler (B), the silicate (C), and the resin former (D) may also be encapsulated in an organic thermoplastic or in a thermoplastic silicone resin, with the proviso that groups for cleavages of O—R bonds continue to be available on the surface of the particle.

The components (A) to (H) used in accordance with the invention may in each case be one single kind of such a component or else a mixture of at least two different kinds of such a component.

When crosslinkable groups are present, the compositions of the invention may be crosslinked (vulcanized), like crosslinkable compositions known to date. The temperatures involved are preferably from 40 to 220° C., with particular preference from 100 to 190° C., and the pressure is atmospheric (unpressurized) or a pressure from 900 to 1100 hPa. It is, however, also possible to employ higher or lower temperatures and pressures. Crosslinking may also be carried out photochemically with high-energy radiation, such as visible light with short wavelengths and UV light, for example, or with a combination of thermal and photochemical excitation.

The present invention further provides extrudates and moldings produced by crosslinking the compositions of the invention.

The compositions of the invention and also the crosslinked products produced from them can be employed for all purposes for which crosslinkable organopolysiloxane elastomer compositions are useful, with the advantage of economic, very largely automated, continuous, and error-minimized production of composite parts. This encompasses, for example, the silicone coating or impregnation of any desired substrates, the production of moldings by injection molding, vacuum extrusion or extrusion processes, casting and compression molding, impressions, use as sealing, potting, and encapsulating compositions, adhesives, etc. Particular preference is given to extrudates, calendered and coated products, which are characterized by an assembly which comes about without primer and not mechanically (as by means of undercuts or perforations, for example).

The compositions of the invention have the advantage that they can be produced in a simple process using readily available starting materials and hence economically, and likewise have the advantage that they can be crosslinked both with noble metal catalysis and with peroxide induction, since the additives needed to develop the adhesion are largely insensitive to peroxides. The compositions of the invention have the further advantage that they adhere to substrates without the use of pretreatments, primer application or mechanical aids, and that this adhesion is developed very rapidly, typically in the range of minutes for so-called transport adhesion, which is necessary for separation-free removal from the heating tunnel and for the transport of the composite part. A yet further advantage is that this transport adhesion is already very high, in some cases in the range of the tensile strength or breaking load of one of the components of the assembly.

The compositions of the invention have the still further advantages, that the adhesion is usually boosted further over time as a result of storage or thermal conditioning, and that the adhesion does not decrease as the material ages—in other words, that there is no premature aging of the system. The compositions of the invention have the additional advantage, moreover, that the adhesion is developed without pressure, i.e., that a composite may be produced without application of pressure or further costly and inconvenient operating steps.

Another advantage of the compositions of the invention that the crosslinking compositions, in the elastomer end product, even with high fractions of components (C), (D), and (F), do not exhibit any substantial deterioration in mechanical or other physical properties as compared with compositions not formulated for self-adhesion. This can be explained through the morphological similarity of the additives to the base silicones (A) and (B), which does not lead to negative side effects or separation effects.

The compositions of the invention have yet another advantage, that given an appropriate choice of additives, their crosslinked vulcanizates can be used in direct contact with foods, with the consequence that there is no need to use any costly and inconvenient additional coatings or backings in order to avoid direct contact, and with the consequence that the compositions themselves can be used as food-approved coatings on substrates not suitable for food use.

In the examples described below, all parts and percentage data, unless indicated otherwise, are by weight. Unless indicated otherwise, the examples which follow are carried out under the pressure of the surrounding atmosphere, in other words at 1000 hPa, approximately, and at room temperature, in other words at approximately 20° C., or at a temperature which comes about when the reactants are combined at room temperature without additional heating or cooling.

### EXAMPLES

### Substrates

The adhesion of the silicone elastomers of the invention was tested on the following substrates:

a) Polyamide (PA): Ultramid® A3EG6 (BASF AG)

b) Aluminum (industrial grade; not primed, not anodized)

c) Steel: V2A stainless steel (industrial grade)

d) Copper (industrial grade)

### Example 1

### Production of an Inventive Material and Simulation of Adhesion on Coextrusion

1000 grams of a poly(dimethylmethylvinyl)siloxane having an average chain length of 800 Si—O units as determined by means of ²⁹Si-NMR (Wacker Chemie AG) are introduced and mixed homogeneously in portions with 240 grams of a hydrophilic silica having a BET surface area of approximately 300 m²/g (Wacker Chemie AG, Munich) in a sigma compounder at 120° C. After cooling to room temperature (“RT”), 50 grams of a 3:1:1 mixture of tetraethylsilicate, methyltriethoxysilane, and dimethyldiethoxysilane (all Wacker Chemie AG, Munich) in solution in 100 ml of ethanol are added, and kneading is continued at 40° C. under reduced pressure until the ethanol has evaporated without residue. The resulting formulation is then compounded on the roll at RT with crosslinking additives, as specified in Table 2, for vulcanization, applied in strips to the test specimens described below, vulcanized as described below, and tested. The release forces are reported in Table 1. The material has an average final Shore A hardness of 70 and vulcanizes without pressure and without bubbles.

### Characterization of the Adhesion of a Coextrusion Simulating Test Specimen (Produced as per Example 1)

To characterize the strength of adhesion, 100.0 g of the elastomer material produced in the following examples is applied using a doctor blade or applied as a preformed strip, depending on viscosity, in the form of a layer approximately 6 mm thick, to the substrate surface cleaned with acetone beforehand (size of test specimen approximately 20×60 mm, taped off for approximately 10 mm at each end in order to prevent formation of a composite at these points). The resulting composite is then vulcanized in a forced air drying oven at a temperature of 200° C. for 5 minutes, during which the elastomer material undergoes complete crosslinking; it is then cooled to room temperature. By means of a tension-extension machine, a measurement is then made of the maximum force required in the peel test in order to separate elastomer and substrate from one another completely, i.e., to part the adhesive assembly. The release force is determined in accordance with DIN 53531 and reported in N/mm. Five test specimens are measured for each example, the breaking stress being determined as an average value and the cohesive failure component being determined in percent. Cohesive failure of 0% means that the silicone elastomer was detached completely and without residue from the substrate surface. Cohesive failure of 100% (ideal scenario) means that the separation occurred exclusively through crack propagation within the silicone elastomer or the substrate.

### Example 2

### Adhesion on Coextrusion to Metal Strips

10 kg of self-adhesively formulated silicone material, produced as per Example 1, are supplied to a standard industry extruder and are extruded in the form of a rectangular profile approximately 10 mm wide and approximately 6 mm thick onto a metal strip which is approximately 0.05 mm in thickness and is taped off with a spacing of in each case 4 cm to 2 cm. The uncured composite obtained in this way is vulcanized in a 6 meter hot air tunnel at an effective temperature of 230° C. with a residence time of 3 minutes. After the final composite has cooled, it is cut in the center of each of the taped off areas, and the resultant test specimens are ruptured on the testing machine as in Example 1. The results are reported in Table 1.

### Example 3

### Production of an Inventive Material with a Low Shore A Hardness

1000 grams of a poly(dimethylmethylvinyl)siloxane having an average chain length of 800 Si—O units as determined by means of ²⁹Si-NMR (Wacker Chemie AG) are introduced and mixed homogeneously in portions with 200 grams of a hydrophilic silica having a BET surface area of approximately 300 m²/g (Wacker Chemie AG) in a sigma compounder at 120° C. After cooling to RT, 5 grams of tetraethylsilicate and 5 grams of methyltriethoxysilane (all Wacker Chemie AG) are added in succession, and kneading is continued for an hour at a high shear rate and at 70° C. The resulting formulation is then compounded on the roll at RT with 0.02 gram of butyl titanate (Merck KGaA) and 1 gram of glycidyloxypropyltrimethoxysilane (Degussa AG) and also with crosslinking additives, as indicated in Table 2, for vulcanization, and is vulcanized as described above. The material has an average final Shore A hardness of 45 and vulcanizes without pressure or bubbles.

TABLE 1
(Release force in [N/mm]; cohesive failure component in [%]);
inventive compositions used as per Examples 1 and 3, addition
crosslinked with platinum catalysis

| | PA | | Aluminum | | V2A Steel | | Copper | |
|---|---|---|---|---|---|---|---|---|
| | [N/ | | [N/ | | [N/ | | [N/ | |
| Example | mm] | [%] | mm] | [%] | mm] | [%] | mm] | [%] |
| Simulated | 11.2 | 100 | 13.8 | 100 | 13.0 | 100 | 8.9 | 80 |
| coextrusion | | | | | | | | |
| with material | | | | | | | | |
| from Ex. 1 | | | | | | | | |
| Simulated | 14.2 | 100 | 14.8 | 100 | 12.8 | 100 | 11.7 | 90 |
| coextrusion | | | | | | | | |
| with material | | | | | | | | |
| from Ex. 3 | | | | | | | | |
| Realistic | — | — | 11.6 | 100 | 8.7 | 90 | 6.5 | 80 |
| coextrusion as | | | | | | | | |
| per 2 with | | | | | | | | |
| material from | | | | | | | | |
| Ex. 1 | | | | | | | | |
| Realistic | — | — | 10.5 | 90 | 7.8 | 80 | 5.8 | 70 |
| coextrusion as | | | | | | | | |
| per 2 with | | | | | | | | |
| material from | | | | | | | | |
| Ex. 3 | | | | | | | | |

The values reported in Table 1 demonstrate the high strength of adhesion of coextrudates composed of the addition-crosslinked silicone elastomer of the invention and organic plastics or metals. Particularly noteworthy is the fact that not only the simulated coextrudates but also the realistic coextrudates, even on measurement in the fresh state, in other words while still hot, consistently exhibit approximately 80% of the final adhesion reported in the tables, hence have excellent transport adhesion, and that the final adhesion is achieved immediately after cooling.

Typical mechanical properties of the compositions of the invention are reported in Table 2, in comparison to standard silicones with the same crosslinking system. For examples 1a to 3bS reported in Table 2, the crosslinking was carried out as indicated further on below, either by addition crosslinking using a noble metal catalyst and an H-siloxane having at least two S—H groups on an Si—O main chain of at least 10 Si—O units, or peroxidically using 2,4-dichlorobenzoyl peroxide.

### EXAMPLES

1a inventive material as per Example 1, addition crosslinked with platinum catalysis;

1aS standard silicone material, addition crosslinked with platinum catalysis;

1b inventive material as per Example 1, crosslinked with peroxide induction;

1bS standard silicone material, crosslinked with peroxide induction;

3a inventive material as per Example 3, addition crosslinked with platinum catalysis;

3aS standard silicone material, addition crosslinked with platinum catalysis;

3b inventive material as per Example 1, crosslinked with peroxide induction;

3bS standard silicone material, crosslinked with peroxide induction.

TABLE 2
Profile of mechanical properties of self-adhesive silicone
compositions in comparison with nonself-adhesive silicones

| | | | | | Tear | Com- |
|---|---|---|---|---|---|---|
| Ex- | | Elongation | Tensile | Rebound | propagation | pression |
| am- | Shore | at break | strength | elasticity | resistance | set |
| ple | A | [%] | [N/mm²] | [%] | [N/mm] | [%] |
| 1a | 68 | 680 | 10.3 | 55 | 34 | 30 |
| 1aS | 69 | 880 | 11.0 | 53 | 30 | 25 |
| 1b | 67 | 560 | 9.8 | 55 | 19 | 30 |
| 1bS | 67 | 600 | 10.0 | 55 | 17 | 28 |
| 3a | 45 | 780 | 11.0 | 58 | 32 | 24 |
| 3aS | 45 | 670 | 9.5 | 60 | | |

The results of the mechanical comparison demonstrate that the additives used to achieve self-adhesion in the compositions of the invention do not adversely affect the mechanical properties within the margins of error.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A silicone elastomer composition comprising:
(A) at least one siloxane-containing polymer bearing organic radicals capable of crosslinking,
(B) at least one treated or untreated, fumed or precipitated silica,
(C) at least one silicate containing thermally or hydrolytically cleavable leaving groups O—R², comprising silicate salts or low molecular weight silicate compounds, where R² is H, an organic radical or, instead of O—R², contain a halogen as a leaving group,
(D) at least one resin-forming monomer or oligomer with a linear structure, with the proviso that the resin-forming monomer or oligomer is not a silicate (C),
(E) at least one crosslinking system selected from the group consisting of peroxide-induced crosslinking or noble metal or noble metal catalyzed addition crosslinking.

2. The silicone elastomer composition of claim 1, wherein the crosslinking capable organic radicals capable of crosslinking of the compound (A) comprise aliphatic carbon-carbon multiple bonds.

3. The silicone elastomer composition of claim 1, wherein the silica (B) contains some hydrophilic groups.

4. The silicone elastomer composition of claim 2, wherein the silica (B) contains some hydrophilic groups.

5. The silicone elastomer composition of claim 1, wherein the silicate component (C) includes at least one silicate of the formula (1),
R³R⁴SiR⁵R⁶, (1)
where R³, R⁴, R⁵, and R⁶ are organic or inorganic radicals, a substituent of the structure —O—R⁷, or a halogen radical, where R⁷ is an H or any desired organic radical.

6. The silicone elastomer composition of claim 2, wherein the silicate component (C) includes at least one silicate of the formula (1),
R³R⁴SiR⁵R⁶, (1)
where R³, R⁴, R⁵, and R⁶ are organic or inorganic radicals, a substituent of the structure —O—R⁷, or a halogen radical, where R⁷ is an H or any desired organic radical.

7. The silicone elastomer composition of claim 3, wherein the silicate component (C) includes at least one silicate of the formula (1),
R³R⁴SiR⁵R⁶, (1)
where R³, R⁴, R⁵, and R⁶ are organic or inorganic radicals, a substituent of the structure —O—R⁷, or a halogen radical, where R⁷ is an H or any desired organic radical.

8. The silicone elastomer composition of claim 1, wherein the resin forming monomer or oligomer component (D) includes at least one monomer or oligomer is of the formula (2),
R⁸R⁹(R¹⁰O)Si—OR¹¹ (2)
where R⁸ and R⁹ are any desired organic radical, inorganic radical, or halogen substituted and/or organically substituted linear and branched siloxanes having 1 to 10 Si—O units, and
R¹⁰ and R¹¹ are any desired organic or inorganic radicals, with the proviso that at least one of R¹⁰ and R¹¹ contains a preformed leaving group.

9. The silicone elastomer composition of claim 2, wherein the resin forming monomer or oligomer component (D) includes at least one monomer or oligomer is of the formula (2),
R⁸R⁹(R¹⁰O)Si—OR¹¹ (2)
where R⁸ and R⁹ are any desired organic radical, inorganic radical, or halogen substituted and/or organically substituted linear and branched siloxanes having 1 to 10 Si—O units, and
R¹⁰ and R¹¹ are any desired organic or inorganic radicals, with the proviso that at least one of R¹⁰ and R¹¹ contains a preformed leaving group.

10. The silicone elastomer composition of claim 3, wherein the resin forming monomer or oligomer component (D) includes at least one monomer or oligomer is of the formula (2),
R⁸R⁹(R¹⁰O)Si—OR¹¹ (2)
where R⁸ and R⁹ are any desired organic radical, inorganic radical, or halogen substituted and/or organically substituted linear and branched siloxanes having 1 to 10 Si—O units, and
R¹⁰ and R¹¹ are any desired organic or inorganic radicals, with the proviso that at least one of R¹⁰ and R¹¹ contains a preformed leaving group.

11. The silicone elastomer composition of claim 5, wherein the resin forming monomer or oligomer component (D) includes at least one monomer or oligomer is of the formula (2),
R⁸R⁹(R¹⁰O)Si—OR¹¹ (2)
where R⁸ and R⁹ are any desired organic radical, inorganic radical, or halogen substituted and/or organically substituted linear and branched siloxanes having 1 to 10 Si—O units, and
R¹⁰ and R¹¹ are any desired organic or inorganic radicals, with the proviso that at least one of R¹⁰ and R¹¹ contains a preformed leaving group.

12. A process for producing the silicone elastomer composition of claim 1, which comprises uniformly mixing components (A) to (E) with one another.

13. A process for producing a composite molding from a silicone elastomer composition of claim 1, comprising coextruding, calendering, or overmolding, with or without pressure.

14. An extrudate or molding produced by crosslinking the silicone elastomer composition of claim 1.
